(19) United States
(12) Patent Application Publication
(10) Pub. No.: US 2017/0188136 A1
(43) Pub. Date: Jun. 29, 2017

(54) Microspeaker Enclosure with Air Adsorbent in Resonance Space

(71) Applicant: EM-TECH. Co., Ltd., Busan (KR)

(72) Inventors: Joong Hak Kwon, Gyeongsangnam-do (KR); Ghi Yuun Kang, Seoul (KR); Hwan Ock Choe, Gyeongsangnam-do (KR)

(21) Appl. No.: 15/392,208

(22) Filed: Dec. 28, 2016

(30) Foreign Application Priority Data
Dec. 29, 2015 (KR) 1020150188529

(51) Int. Cl. H04R 1/28

(52) U.S. Cl. CPC H04R 1/288; H04R 1/2819

(57) ABSTRACT

The present invention aims to provide a microspeaker with enhanced low frequency characteristics, by arranging an adsorbent for adsorbing the air in a resonance space and defining a virtual back volume by the air adsorption of the adsorbent. According to an aspect of the present invention, there is provided a microspeaker enclosure with an air adsorbent, including a microspeaker, an enclosure with the microspeaker provided therein, the enclosure defining a resonance space, and an air adsorbent applied to the resonance space of the enclosure, wherein an air adsorption mole ratio per unit volume of the air adsorbent based on a change in the unit pressure is 40.6 mol/m³·atm.

### PRIORITY CLAIM

The present application claims priority to Korean Patent Application No. 10-2015-0188529 filed on 29 Dec. 2015, the content of said application incorporated herein by reference in its entirety.

### TECHNICAL FIELD

The present invention aims to provide a microspeaker with enhanced properties of low frequency sound, by arranging an adsorbent for adsorbing the air in a resonance space and defining a virtual back volume by the air adsorption of the adsorbent.

### BACKGROUND

A microspeaker is provided in a portable device, etc. to generate sound. With recent developments of mobile devices, the microspeaker has been used for various devices. In particular, the latest mobile device tends to have a light weight, small size, and slim shape to facilitate portability, and accordingly, the microspeaker mounted in the mobile device is required to have a small size and slim shape.

However, in the case of a microspeaker having a small size and slim shape, an area of a diaphragm decreases, and a size of a resonance space in which the sound generated by vibration of the diaphragm is resonated and amplified also decreases, as a result of which a sound pressure level (SPL) decreases. Such decrease in the sound pressure level is particularly pronounced at low frequencies. There has been developed a technology of improving a low frequency sound pressure level, by arranging an air adsorbent in a resonance space, so that the air adsorbent adsorbs air molecules and defines a virtual acoustic space, to enhance a low frequency sound pressure level.

EP 2 424 270 B1 discloses arranging a zeolite material in a resonance space as an adsorbent, wherein a mass ratio of silicon composing zeolite particles to aluminum is at least 200.

In addition, U.S. Pat. No. 8,687,836 B2 discloses adopting silicon-based zeolite, which contains a small amount of second metal on a silicon basis, as an air adsorbent material in an enclosure, wherein a mass ratio of silicon to the second metal is equal to or less than 200.

EP 2 424 270 B1 discloses arranging a zeolite material in a resonance space as an adsorbent, wherein a mass ratio of silicon composing zeolite particles to aluminum is at least 200.

However, the technologies disclosed in EP 2 424 270 B1 and U.S. Pat. No. 8,687,836 B2 do not consider that, when the adsorbent is arranged in the resonance space to define the virtual acoustic space, the actual resonance space decreases as much as the space occupied by the adsorbent.

### SUMMARY

An object of the present invention is to provide a microspeaker with improved vibration properties at low frequencies, by considering a ratio of a space occupied by an adsorbent to an actual resonance space left, when the adsorbent is arranged in the resonance space.

According to an aspect of the present invention, there is provided a microspeaker enclosure with an air adsorbent, including a microspeaker, an enclosure with the microspeaker provided therein, the enclosure defining a resonance space, and an air adsorbent applied to the resonance space of the enclosure, wherein an air adsorption mole ratio per unit volume of the air adsorbent based on a change in the unit pressure is 40.6 mol/m³·atm.

In some embodiments, the ratio of the air to the volume of the air adsorbent applied to the enclosure satisfies

$${V}_{a} > \frac{{DV}_{n} Δ PRT}{{P}_{0}} .$$

Also, in some embodiments, a change in the pressure of the enclosure takes into account an effective diaphragm area of the speaker and a mechanical maximum allowable amplitude of the diaphragm, and a maximum value of the change in the pressure of the enclosure satisfies

$${( Δ P )}_{max} = - \frac{{P}_{0} {S}_{d} {X}_{mech}}{{V}_{cc}} .$$

Further, in some embodiments, when the effective diaphragm area of the microspeaker is equal to or greater than 1.2 cm² and the maximum allowable amplitude is 0.4 mm, Vₐ/Vₙ is equal to or greater than 0.1.

The microspeaker enclosure with the air adsorbent according to the present invention can substantially improve a sound pressure level in a low frequency range, as compared with an enclosure without an air adsorbent, by considering a change in the equivalent stiffness based on an air adsorption rate of the air adsorbent arranged in the resonance space and defining an air adsorption mole ratio per unit volume of the air adsorbent.

Moreover, the microspeaker enclosure with the air adsorbent according to the present invention can substantially improve a sound pressure level in a low frequency range, as compared with an enclosure without an air adsorbent, by considering a ratio of the space occupied by the air adsorbent to the space occupied by the air in the application of the air adsorbent.

Those skilled in the art will recognize additional features and advantages upon reading the following detailed description, and upon viewing the accompanying drawings.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a schematic view illustrating vibration characteristic factors of a diaphragm associated with a sound pressure level that determine the sound pressure level;

FIG. 2 is a view illustrating a movement of a vibration system of a microspeaker using a primary induction system;

FIG. 3 is a schematic view for the calculation of the equivalent stiffness of a box space where a microspeaker is provided in an enclosure;

FIG. 4 is a schematic view illustrating a state where an air adsorbent is filled in the enclosure with the microspeaker provided therein;

FIG. 5 is a graph showing a change in the equivalent stiffness based on an air adsorption rate of the air adsorbent;

FIG. 6 is a graph showing analysis of low frequency response characteristics based on an air adsorption rate of the air adsorbent; and

FIG. 7 is a graph showing a change in the low frequency sound pressure level based on a ratio of the adsorbent applied to the enclosure to pores.

### DETAILED DESCRIPTION

Hereinafter, an embodiment of a microspeaker enclosure with an air adsorbent in a resonance space according to the present invention will be described in detail with reference to the accompanying drawings.

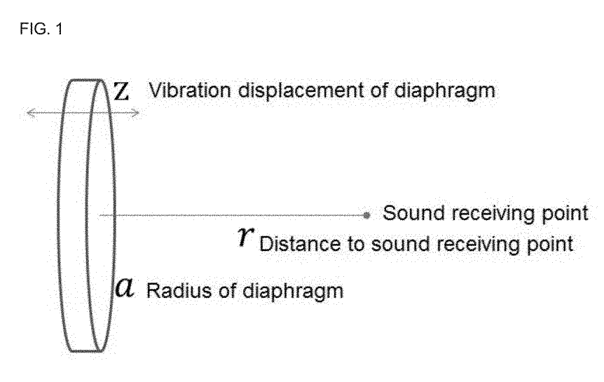

FIG. 1 is a schematic view illustrating vibration characteristic factors of a diaphragm associated with a sound pressure level that determine the sound pressure level. When it is assumed that a vibration displacement of the diaphragm is Z, a distance from the diaphragm to a sound receiving point is r, a radius of the diaphragm is a, a vibration frequency of the diaphragm is f, and an air density is ρ₀, a sound pressure P can be expressed as follows:

$$\vert P \vert = \{ {( 2 π f )}^{2} \frac{{ρ}_{0} {a}^{2}}{2 r} \} \vert z \vert \qquad ( Equation 1.1 )$$

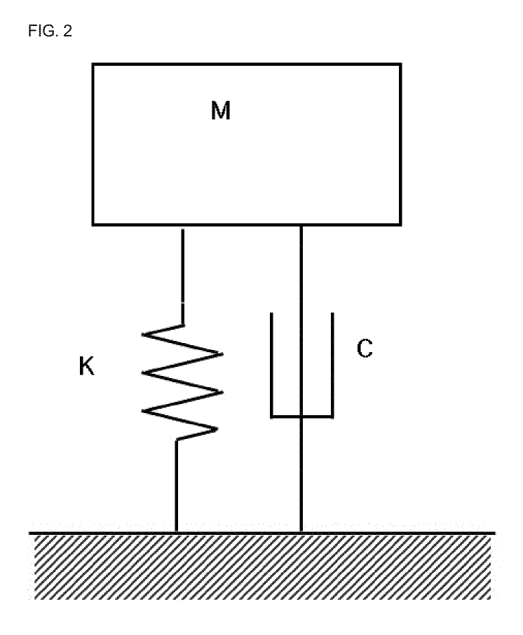

FIG. 2 is a view illustrating a movement of a vibration system of the microspeaker using a primary induction system. When it is assumed that M denotes a weight of the vibration system including a diaphragm, a voice coil, etc., C denotes attenuation of the vibration system, K denotes stiffness of the vibration system, and F denotes an electromagnetic force generated in the coil, the vibration displacement Z of the diaphragm can be expressed as follows:

$$Z = \frac{F}{\sqrt{{( K - M {ω}^{2} )}^{2} + {( C ω )}^{2}}} \\ ω = 2 π f \qquad ( Equation 2.1 )$$

Here, if a vibration frequency ω is lower than a resonant frequency, the vibration displacement is significantly influenced by the stiffness K of the vibration system as follows:

$$Z = \frac{F}{\sqrt{{( K - M / {ω}^{2} )}^{2} + {( C / ω )}^{2}}} = \frac{F}{K} \qquad ( Equation 2.2 )$$

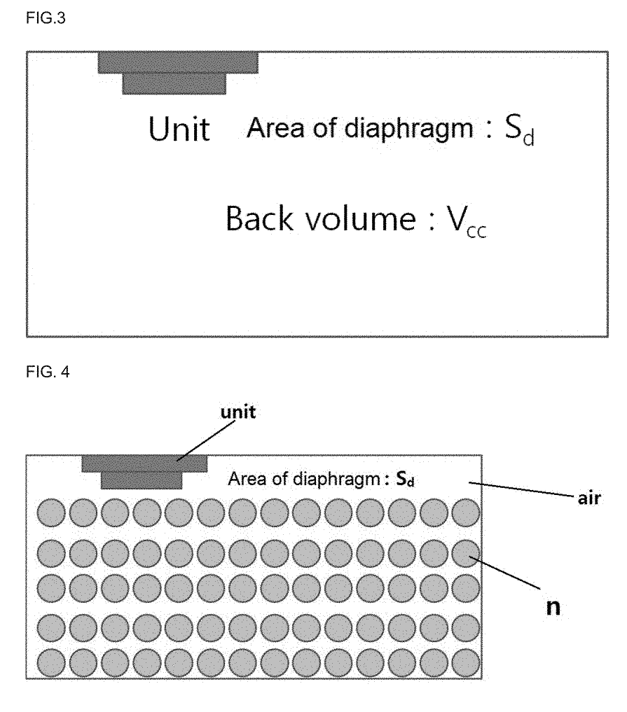

FIG. 3 is a schematic view for the calculation of the equivalent stiffness of a box space where a microspeaker is provided in an enclosure.

When the microspeaker is provided in the enclosure, a resonance space (back volume) in the box-shaped enclosure serves as another stiffening element to thereby increase stiffness of a speaker system, and the total stiffness of the microspeaker enclosure (Kₜₒₜₐₗ) is the sum of the stiffness of the microspeaker (Kᵤₙᵢₜ) and the equivalent stiffness of the resonance space (K_{cc}), which can be expressed by Kₜₒₜₐₗ=Kᵤₙᵢₜ+K_{cc}.

Here, when it is assumed that an area of the diaphragm provided in the microspeaker is S_{d} and a volume of the resonance space in the enclosure with the microspeaker provided therein is V_{cc}, stiffness K_{cc} increased due to the resonance space of the enclosure can be expressed by:

$${K}_{cc} = \frac{{ρ}_{0} {c}^{2} {S}_{d}^{2}}{{V}_{cc}} . \qquad ( Equation 3.1 )$$

The equivalent stiffness of the space in the enclosure at a low capacity can be demonstrated as follows.

In the case of a constant temperature, the product of the pressure and volume of the space in the enclosure has a constant value (ideal gas state equation), which can be expressed by:

P₀V_{cc}=nRT=const. (Equation 3.2).

As the diaphragm of the speaker moves, the volume of the space in the enclosure changes, so the pressure of the resonance space changes, which can be expressed by:

P₀V_{cc}=(P₀+ΔP)(V_{cc}+ΔV) (Equation 3.3)

0=P₀ΔV+ΔPV_{cc}+ΔPΔV (Equation 3.4)

As the product of a pressure variation and a volume variation is relatively very small, which can be expressed by:

ΔPΔV=0, so ΔPV_{cc}=−P₀ΔV (Equation 3.5).

A force acting on the diaphragm due to the change in the pressure is proportional to the area of the diaphragm, which can be expressed by:

$$F = {S}_{d} Δ P \\ Δ P = \frac{F}{{S}_{d}} . \qquad ( Equation 3.6 )$$

In addition, the change in the volume caused by the movement of the diaphragm can be expressed by the product of the effective diaphragm area and the vibration displacement as given by:

ΔV=S_{d}z (Equation 3.7)

When the air is used as a medium, an acoustic impedance Z can be expressed by:

$$Z = \frac{{P}_{0}}{c} = {ρ}_{0} c \\ {P}_{0} = {ρ}_{0} {c}^{2} , \qquad ( Equation 3.8 )$$

which can be organized again as:

$$Δ {PV}_{cc} = - {P}_{0} Δ V \\ ( \frac{F}{{S}_{d}} ) {V}_{cc} = - ( {ρ}_{0} {c}^{2} ) ( {S}_{d} z ) \\ F = - \frac{{ρ}_{0} {c}^{2} {S}_{d}^{2}}{{V}_{cc}} z . \qquad ( Equation 3.9 )$$

The equivalent stiffness of the resonance space (back volume) can be organized according to the Hooke's law, which can be expressed by:

$${K}_{cc} = \frac{{ρ}_{0} {c}^{2} {S}_{d}^{2}}{{V}_{cc}} . \qquad ( Equation 3.1 )$$

Therefore, when the volume of the resonance space decreases, the equivalent stiffness of the air increases and the low frequency sound pressure level decreases.

In the case of a material used as an air adsorbent, an air adsorption amount is proportional to the pressure.

FIG. 4 is a schematic view illustrating a state where the air adsorbent is filled in the enclosure with the microspeaker provided therein.

The microspeaker (unit) is provided in the enclosure, the resonance space (back volume) of the enclosure is filled with a certain amount of air adsorbent n, and the remaining space is occupied by the air. The total volume V_{cc} of the resonance space is divided into a volume Vₐ occupied by the air and a volume Vₙ occupied by the adsorbent, which can be expressed by:

V_{cc}=Vₐ+Vₙ (Equation 4.1),

and according to the ideal gas state equation, which can be expressed by:

P₀Vₐ=n₀RT (Equation 4.2),

the air adsorption amount based on the change in the pressure can be expressed by:

Δn=DVₙΔP (Equation 4.3).

As the pressure changes in response to a change in the volume caused by a change in the amplitude of the diaphragm, and at this time, the air mole number in the space changes due to a change in the adsorption amount of the air adsorbent, which can be expressed by:

P₀Vₐ=n₀RT

(P₀+ΔP)(Vₐ+ΔV)=(n₀−Δn)RT

(P₀+ΔP)(Vₐ+ΔV)=(n₀−DVₙΔP)RT

P_{C}Vₐ+ΔPVₐ+P_{C}ΔV+ΔPΔV=n_{C}RT−DVₙΔPRT (Equation 4.4).

As the product of a pressure variation and a volume variation is relatively very small, it can be organized as follows:

ΔPΔV≅0

ΔPVₐ+P₀ΔV=−DVₙΔPRT

ΔP(Vₐ+DVₙRT)=−P₀ΔV (Equation 4.5).

The force acting on the diaphragm due to the change in the pressure is associated with the area of the diaphragm, which can be expressed by:

$$F = {S}_{d} Δ P \\ Δ P = \frac{F}{{S}_{d}} \qquad ( Equation 3.6 )$$

The change in the volume caused by the movement of the diaphragm is expressed by the product of the effective diaphragm area and the vibration displacement, which can be expressed by:

ΔV=S_{d}z (Equation 3.7).

When the air is used as a medium, the acoustic impedance Z can be expressed by:

$$Z = \frac{{P}_{0}}{c} = {ρ}_{0} c \\ {P}_{0} = {ρ}_{0} {c}^{2} , \qquad ( Equation 3.8 )$$

which can be organized again as:

$$Δ P ( {V}_{a} + {DV}_{n} RT ) = - {P}_{0} Δ V \\ ( \frac{F}{{S}_{d}} ) ( {V}_{a} + {DV}_{n} RT ) = - ( {ρ}_{0} {c}^{2} ) ( {S}_{d} z ) \\ F = - \frac{{ρ}_{0} {c}^{2} {S}_{d}^{2}}{( {V}_{a} + {DV}_{n} RT )} z . \qquad ( Equation 4.6 )$$

The equivalent stiffness of the resonance space (back volume) can be organized according to the Hooke's law, which can be expressed by:

$${K}_{cc} = \frac{{ρ}_{0} {c}^{2} {S}_{d}^{2}}{( {V}_{a} + {DV}_{n} RT )} . \qquad ( Equation 4.7 )$$

In comparison of the equivalent stiffness before and after the application of the air adsorbent to the enclosure, the equivalent stiffness before the application of the adsorbent can be expressed by:

$${K}_{cc} = \frac{{ρ}_{0} {c}^{2} {S}_{d}^{2}}{{V}_{cc}} , \qquad ( Equation 3.1 )$$

and the equivalent stiffness after the application of the adsorbent can be expressed by:

$$\frac{{ρ}_{0} {c}^{2} {S}_{d}^{2}}{( {V}_{a} + {DV}_{n} RT )} . \qquad ( Equation 4.7 )$$

Thus, in order to ensure that the low frequency sound is more enhanced in the application of the air adsorbent than in the non-application of the air adsorbent, the following conditions are satisfied:

V_{cc}=Vₐ+DVₙRT,

Vₐ+Vₙ<Vₐ+DVₙRT

Vₙ<DVₙRT (Equation 4.8).

That is to say, in the application of the air adsorbent, a minimum value of the air adsorption rate required to enhance the low frequency sound can be expressed by:

$${V}_{n} < {DV}_{n} RT \\ D > \frac{1}{RT} . \qquad ( Equation 4.9 )$$

Under the conditions such as a gas constant of the air and a normal temperature, when it is assumed that the gas constant R is 8.21×10⁻⁵ m³·atm/mol·K and the normal temperature is 300K, D>40.6 mol/m³·atm.

Therefore, the minimum value of the variation rate of the adsorption amount based on the change in the pressure per unit volume is 40.6 mol/m³·atm.

Meanwhile, the microspeaker (unit) is provided in the enclosure, the resonance space (back volume) of the enclosure is filled with a certain amount of air adsorbent n, and the remaining space is occupied by the air. When the total volume V_{cc} of the resonance space is divided into a volume Vₐ occupied by the air and a volume Vₙ occupied by the adsorbent, an air adsorption mole number per unit volume based on the change in the pressure is D, and an initial air mole number is n₀, an air adsorption amount based on the change in the pressure can be expressed by:

Δn=DVₙΔP (Equation 5.1).

Here, as the air adsorption amount cannot exceed the initial air mole number, the following condition is satisfied:

n₀>DVₙΔP (Equation 5.2).

The initial mole number no can be expressed by:

$${P}_{0} {V}_{a} = {n}_{0} RT$$

$${n}_{0} = \frac{{P}_{0} {V}_{a}}{RT} ,$$

which can be organized again as:

$${n}_{0} > {DV}_{n} Δ P \\ \frac{{P}_{0} {V}_{a}}{RT} > {DV}_{n} Δ P \\ {V}_{a} > \frac{{DV}_{n} Δ PRT}{{P}_{0}} . \qquad ( Equation 5.3 )$$

Taking into account a mechanical maximum amplitude X_{mech}, which is a maximum displacement of the diaphragm which does not have a physical contact, as one of the TS parameters of the speaker, a maximum pressure change can be expressed as follows:

$$\begin{matrix}{( Δ P )}_{max} {( {V}_{a} + {DV}_{n} RT )}_{min} = - {{P}_{0} ( Δ V )}_{max} \\ {( Δ P )}_{max} {( {V}_{a} + {DV}_{n} RT )}_{min} = - {P}_{0} ( {S}_{d} {X}_{mech} ) \\ {( {V}_{a} + {DV}_{n} RT )}_{min} = {{V}_{cc} \\ ( Δ P )}_{max} = - \frac{{P}_{0} {S}_{d} {X}_{mech}}{{V}_{cc}} & ( Equation 5.4 ) \\ {V}_{a} > \frac{{DV}_{n} RT}{{P}_{0}} \frac{{P}_{0} {S}_{d} {X}_{mech}}{{V}_{cc}} & ( Equation 5.5 ) \\ \frac{{V}_{a}}{{V}_{n}} > \frac{{S}_{d} {X}_{mech} DRT}{{V}_{cc}} & ( Equation 5.6 )\end{matrix}$$

Here, when the minimum value of the adsorption mole number D per unit volume based on the change in the pressure is 40.6, and for the sizes of the enclosure and the microspeaker, the resonance space V_{cc}, is 0.6 cc, the effective diaphragm area S_{d} is 1.2 cm², the maximum allowable amplitude X_{mech} is 0.4 mm, and

$$\frac{{V}_{a}}{{V}_{n}} > 0.08 .$$

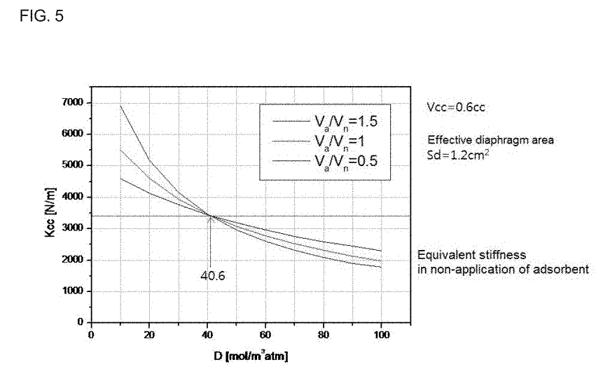

FIG. 5 is a graph showing a change in the equivalent stiffness based on the air adsorption rate of the air adsorbent. Here, for the sizes of the enclosure and the microspeaker, the resonance space V_{cc} is 0.6 cc and the effective diaphragm area S_{d} is 1.2 cm². The equivalent stiffness becomes smaller in the application of the air adsorbent than in the non-application of the air adsorbent, when the adsorption rate D per unit volume based on the change in the pressure of the air adsorbent is equal to or greater than 40.6 mol/m³·atm. It can be seen that the equivalent stiffness of the enclosure becomes smaller, when D is equal to or greater than 40.6 mol/m³·atm, regardless of the change in Vₐ/Vₙ.

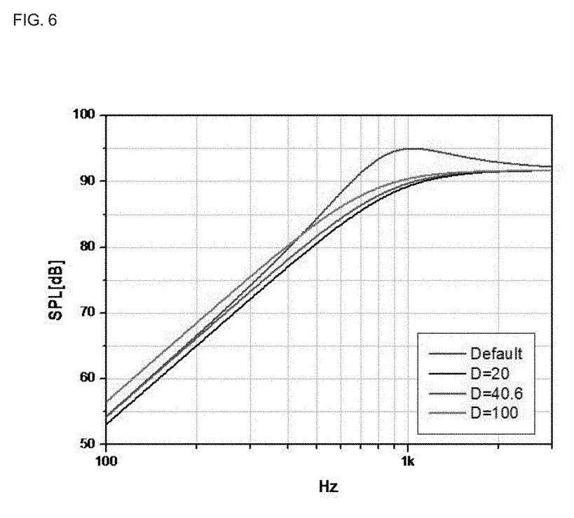

FIG. 6 is a graph showing analysis of low frequency response characteristics of the speaker based on an adsorption rate of the air adsorbent. Here, for the sizes of the enclosure and the microspeaker, the resonance space V_{cc} is 0.6 cc and the effective diaphragm area S_{d} is 1.2 cm².

The low frequency sound pressure level (SPL) is almost the same both in the application of the air adsorbent and the non-application of the air adsorbent, when the air adsorption rate D is 40.6 mol/m³·atm, but the low frequency sound pressure level (SPL) is more remarkably improved in the application of the air adsorbent than in the non-application of the air adsorbent, when D is 100 mol/m³·atm. On the contrary, the low frequency sound pressure level (SPL) becomes lower in the application of the air adsorbent than in the non-application of the air adsorbent, when D is 20 mol/m³·atm, as a result of which it is apparent that D should be at least 40.6 mol/m³ atm in the application of the air adsorbent.

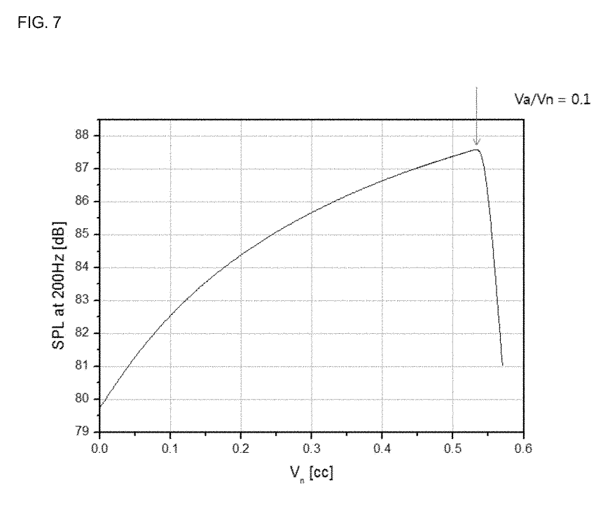

FIG. 7 is a graph showing a change in the low frequency sound pressure level based on a ratio of the adsorbent applied to the enclosure to pores. The change in the sound pressure level based on the volume Vₙ has been measured and illustrated, when the resonance space V_{cc} of the enclosure is 0.6 cc, the effective diaphragm area S_{d} is 1.2 cm², and the adsorption rate D is 225 mol/m³·atm. The sound pressure level increases as the volume Vₙ increases, until Vₐ/Vₙ reaches 0.1, but the sound pressure level starts to decrease when Vₐ/Vₙ drops below 0.1. That is to say, the volume occupied by the air in the resonance space of the enclosure should be at least 10% of the space occupied by the adsorbent.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A microspeaker enclosure with an air adsorbent; comprising:
a microspeaker;
an enclosure with the microspeaker provided in the enclosure, the enclosure defining a resonance space; and
an air adsorbent applied to the resonance space of the enclosure,
wherein an air adsorption mole ratio per unit volume of the air adsorbent based on a change in unit pressure is 40.6 mol/m³·atm.

2. The microspeaker enclosure of claim 1, wherein a ratio of the air to the volume of the air adsorbent applied to the enclosure satisfies
$${V}_{a} > \frac{{DV}_{n} Δ PRT}{{P}_{0}} ,$$
where Vₐ is a volume occupied by the air; Vₙ is a volume occupied by the adsorbent, D is an air adsorption mole number per unit volume based on the change in pressure, R is a gas constant, T is temperature, P₀ is an initial pressure, and ΔP is a pressure variation.

3. The microspeaker enclosure of claim 2, wherein a change in the pressure of the enclosure takes into account an effective diaphragm area of the microspeaker and a mechanical maximum allowable amplitude of a diaphragm provided in the microspeaker, and a maximum value of the change in the pressure of the enclosure satisfies
$${( Δ P )}_{max} = - \frac{{P}_{0} {S}_{d} {X}_{mech}}{{V}_{cc}} ,$$
where ΔP is a pressure variation, P₀ is an initial pressure, Sd is an area of the diaphragm provided in the microspeaker, X_{mech} is a mechanical maximum amplitude of the diaphragm provided in the microspeaker, and V_{cc} is a volume of the resonance space of the enclosure.

4. The microspeaker enclosure of claim 3, wherein when the effective diaphragm area of the microspeaker is equal to or greater than 1.2 cm² and the maximum allowable amplitude is 0.4 mm, Vₐ/Vₙ is equal to or greater than 0.1.

5. The microspeaker enclosure of claim 2, wherein when an effective diaphragm area of the microspeaker is equal to or greater than 1.2 cm² and a mechanical maximum allowable amplitude of a diaphragm provided in the microspeaker is 0.4 mm, Vₐ/Vₙ is equal to or greater than 0.1.
